(19) United States
(12) Patent Application Publication
(10) Pub. No.: US 2024/0177632 A1
(43) Pub. Date: May 30, 2024

(54) DEVICES AND METHODS ASSESSING CHIROPRACTIC TECHNIQUE

(71) Applicant: Beau Parmenter, Henderson, MI (US)

(72) Inventor: Beau Parmenter, Henderson, MI (US)

(21) Appl. No.: 18/509,133

(22) Filed: Nov. 14, 2023

Related U.S. Application Data
(60) Provisional application No. 63/383,585, filed on Nov. 14, 2022.

(51) Int. Cl. G09B 23/32

(52) U.S. Cl. CPC G09B 23/32

(57) ABSTRACT

Described herein are sensorized figures that are configured for practicing manipulative techniques and providing real-time feedback.

### CROSS-REFERENCE TO RELATED APPLICATIONS

This application claims the priority benefit of U.S. Provisional Patent Application Ser. No. 63/383,585, filed Nov. 14, 2022, the contents of which is herein incorporated by reference in its entirety.

### INCORPORATION BY REFERENCE

All publications and patent applications mentioned in this specification are herein incorporated by reference in their entirety, as if each individual publication or patent application was specifically and individually indicated to be incorporated by reference in its entirety.

### TECHNICAL FIELD

This disclosure relates generally to the field of neuromusculoskeletal medicine, and more specifically to the field of skeletal, bone, muscle, and nerve manipulation, such as, alignment, adjustment, and massage. Described herein are systems and methods for assessing a practitioner's technique and providing instant feedback.

### BACKGROUND

Currently, aspiring students and practitioners, such as chiropractors, doctors of osteopathic medicine, massage therapists, kinesiologists, etc., rely on in-person training with established practitioners. The training includes practicing various manipulative techniques on manikins, but it is unclear whether the technique has been performed correctly or adequately, for example, did the trainee apply enough pressure or force in the right location to achieve a desired outcome. Additionally, the recent pandemic has further made it difficult for practitioners to complete their training and receive adequate feedback.

Further, all individuals receiving any manipulative-type of treatment vary as to their problems, the location of their problems, sensitivity, and pain thresholds. Practicing practitioners rely on a patient's feedback and history in order to adequately apply any manipulative technique. However, without such feedback, the practitioner would not be completely aware of their effect on the problem area.

Accordingly, there exists a need for improved systems and methods for training, assessing, and providing instant feedback on human manipulative techniques.

### BRIEF DESCRIPTION OF THE DRAWINGS

The foregoing is a summary, and thus, necessarily limited in detail. The above-mentioned aspects, as well as other aspects, features, and advantages of the present technology are described below in connection with various embodiments, with reference made to the accompanying drawings.

FIG. 1 shows a diagram of one embodiment of a device for assessing a chiropractic technique.

FIG. 2 shows a posterior view of one embodiment of a device for assessing spinal-based chiropractic techniques.

FIG. 3 shows an anterior view of one embodiment of a device for assessing extremity-based chiropractic techniques.

FIG. 4 shows a flow chart of one embodiment of a method for assessing a manipulative technique and providing feedback.

The illustrated embodiments are merely examples and are not intended to limit the disclosure. The schematics are drawn to illustrate features and concepts and are not necessarily drawn to scale.

### DETAILED DESCRIPTION

The foregoing is a summary, and thus, necessarily limited in detail. The above-mentioned aspects, as well as other aspects, features, and advantages of the present technology will now be described in connection with various embodiments. The inclusion of the following embodiments is not intended to limit the disclosure to these embodiments, but rather to enable any person skilled in the art to make and use the contemplated invention(s). Other embodiments may be utilized, and modifications may be made without departing from the spirit or scope of the subject matter presented herein. Aspects of the disclosure, as described and illustrated herein, can be arranged, combined, modified, and designed in a variety of different formulations, all of which are explicitly contemplated and form part of this disclosure.

In general, any of the devices or methods described herein may be configured to distinguish between and/or assess the quality of a manipulative technique, for example, a chiropractic technique, such as: diversified technique, atlas orthogonal technique, extremity manipulating/adjusting, activator techniques, Graston® technique, Koren specific technique, Cox flexion/distraction technique, Gonstead technique, torque release technique, trigenics technique, etc. The present disclosure may also be used by practitioners using osteopathic manipulative treatments, kinesiology treatments, or massage therapy treatments, such as, field craniosacral therapy, deep tissue massage, reflexology, etc.

In any of the embodiment described herein, one or more or a variety of sensors may be used based on the location of the sensor, the desired readout, the sensitivity, etc. For example, a sensor may include: pressure transducers, force transducers, motion sensors, conductive touch sensors, tactile sensors, piezoresistive sensor, torque sensors, or combinations thereof. The sensors may be adjustable to provide a range of sensitivities. Alternatively, the system may be configured to easily remove and replace sensors depending upon a desired sensitivity. For example, one or more sensors may reside in a pocket or be removably coupled to the figure, such that the one or more sensors can be moved, removed, replaced, or otherwise altered.

In any of the embodiments described herein, a figure, such as a life-size, anatomically correct manikin, is configured to simulate a human while providing instant feedback to trainees, practitioners, or other users, during manipulation. The figure may comprise material that simulates a realistic feel of a human; for example, some materials may include foam (e.g., polyurethane foam), plastic (e.g., vinyl plastic), or some other pliable material formed to simulate flesh and soft tissues, and plastic or some other denser material to simulate bones, ligaments, and a spine. The spine may be configured to simulate a spine of a human, such that it comprises discs and soft tissue therebetween. It will also be appreciated that the figure can be configured to separate fingers and toes.

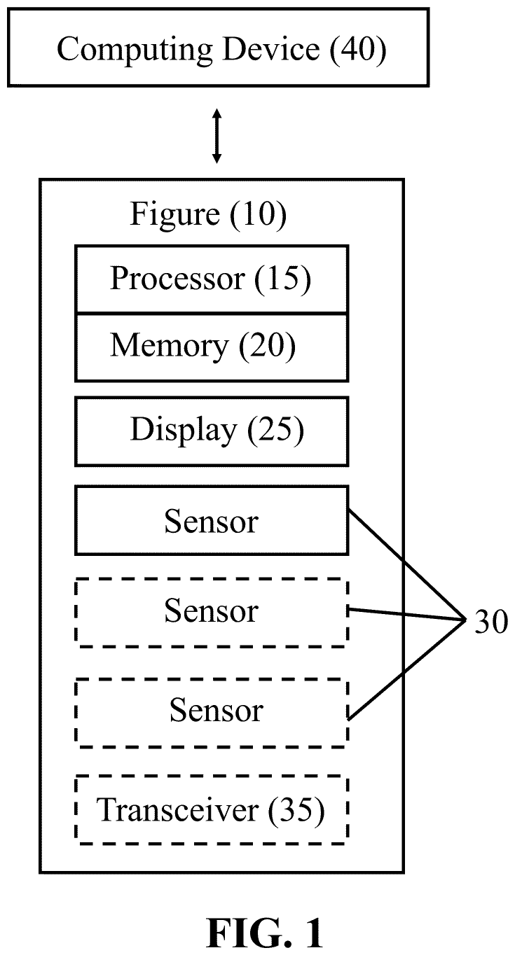

FIG. 1 shows a diagram of one embodiment of a system for assessing either or both of a spinal and extremity-based manipulation technique and providing feedback. In some embodiments, all processing occurs at FIG. 10 such that, for example, the FIG. 10 is configured to provide an instant alert or feedback to a user during and/or after a manipulative technique is performed. In such embodiments, the FIG. 10 can include a processor 15, memory 20, an indicator 25 (e.g., light-based panel, display, sound-based indicator, etc.), and a plurality of sensors 30 positioned at various locations on and/or embedded within the FIG. 10. The processor 15 is communicatively coupled to a computer readable medium and memory 20 having instructions stored thereon for executing a method. The processor 15 may be further communicatively coupled to one or more sensors 30. The method may include receiving sensor data from the one or more sensors 30, analyzing the sensor data, optionally filtering the sensor data for artifacts, noise, etc., and outputting an indication of the manipulative technique. Outputting may include a visual, audio, or tactile output. For example, the FIG. 10 may be configured with display 25 having a visual output that displays an assessment and/or feedback to the user. The display 25, may include one or more of: a light panel that shows a particular color to indicate a quality of a technique (e.g., green for good, yellow for needs work, and red for not adequate) or a screen that displays textual or picture information, such as indicators that display that the user requires decreased or increased pressure and/or the user is performing the manipulation in a correct or incorrect position and requires repositioning the technique. Further, for example, an audio output may comprise positive or negative sounds to indicate the quality or inadequacy of the technique, respectively, or may include vocalized feedback (e.g., apply more or less pressure, adjust a positioning of your technique, etc.). Still further, for example, a tactile output, such as, for example, by embedding a piezoresistive sensor in the FIG. 10, may comprise different types of vibrations in response to a technique being performed satisfactorily or inadequately and/or the positioning is correct or incorrect. For example, if inadequate, the feedback, or consequence, may mimic a patient writhing in pain, while if satisfactory, the feedback may be a slight vibration or minor movement.

In other embodiments, FIG. 10 comprises a transceiver 35 that is communicatively coupled (e.g., wirelessly) or a wired connection to a computing device 40 that processes the sensor data and outputs an indication of the quality of the manipulative technique. The computing device 40 may be a local computing device, for example in the case of a wired connection, or may be a remote computing device, for example a server, mobile device, laptop, wearable, etc. Computing device 40 may comprise a processor communicatively coupled to a computer readable medium and memory having instructions stored thereon for executing a method, similar to the system and method described above but executed remotely. The sensor data from sensors 30 may be transmitted via an antenna of the transceiver 35, or via a wired connection, to computing device 40 for processing. The computing device 40 may display an output of the received and processed sensor data and/or may transmit the output to a user computing device. For example, the computing device 40 or a user computing device may include an application stored thereon that logs various training sessions, an analysis of each training session, and/or feedback for each training session. Further, in some embodiments, the application may include session statistics, for example a percent accuracy, location-based accuracy (e.g., is the student better at spinal vs. extremity adjustments, is the student better at back vs. hip adjustments, etc.), frequency of training, etc. The session statistics may be transmitted to a computing device or displayed on a display of the FIG. 10.

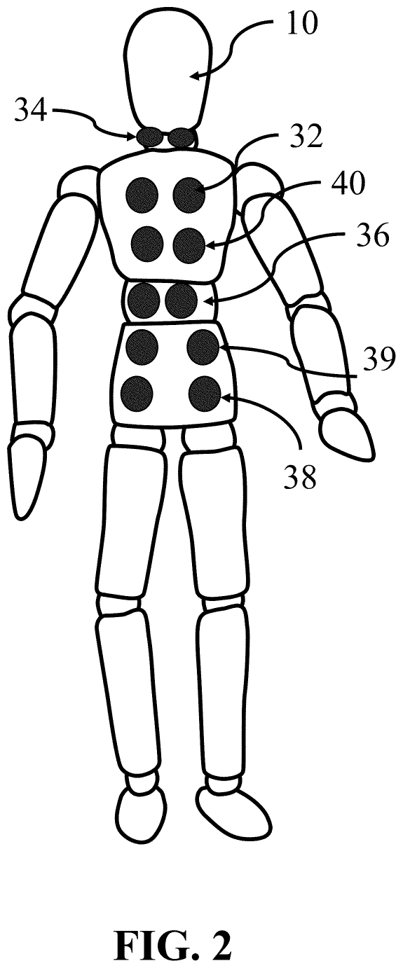

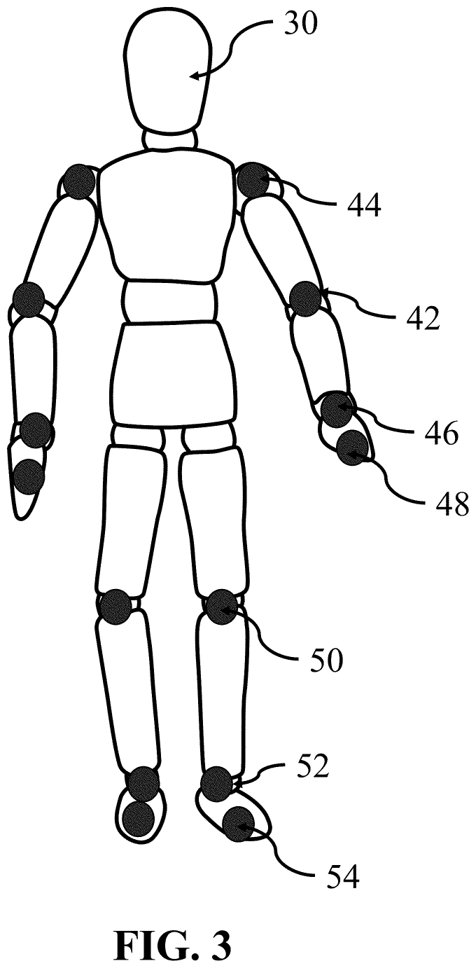

FIGS. 2-3 show various embodiments of a sensorized FIG. 10 that is configured for assessment of spinal-based or extremity-based manipulations, such as spinal adjustments, neck adjustments, or other areas around the spinal cord. In some embodiments, FIG. 10 may comprise an internal skeleton comprising one or more embedded sensors positioned thereon and located at anatomical regions that are typically subjected to manipulative techniques. Alternatively, FIG. 10 may not comprise the internal skeleton, but may alternatively comprise one or more sensors positioned at anatomical regions that are typically subjected to manipulative techniques. For example, as shown in FIG. 2, sensors for assessing one or more spinal-based techniques may be positioned in, on, or near a neck region 34; an upper back region 32; a mid-back region 40; a lower back region 36; a hip region 39; a shoulder region; a torso region; a buttocks region 38; etc. Further for example, as shown in FIG. 3, sensors for assessing one or more extremity-based techniques may be positioned in, on, or near a shoulder region 44; elbow region 42; wrist region 46; hand region 48; palm region; finger region; hip region; buttocks region; knee region 50; ankle region 52; foot region 54; toc region; etc.

The sensors 30 may include one or more adjustable sensors that are easily configured to change the sensitivity. For example, a male patient that requires manipulation may be larger in an area in comparison to a petite female requiring manipulation in that area. The male patient may also have a higher threshold of pain tolerance, thereby able to withstand a greater pressure, or may require more force for manipulation. In this manner, an adjustable pressure sensor may be configured to adjust its range of sensitivity between the male and the female. As another example, a female may have more flexibility in a joint area than a male. Therefore, an adjustable, or variable, torque sensor range may be adjusted to reflect a greater rotation in a female's hips, for example. Alternatively, the sensors 30 may be configured for easy removal and are replaceable with sensors of different ranging sensitivities. In one embodiment of the present invention, the sensors measure and transfer the data to the processor 15 and/or computing device 40 to provide the results (e.g., immediately, on-demand, etc.).

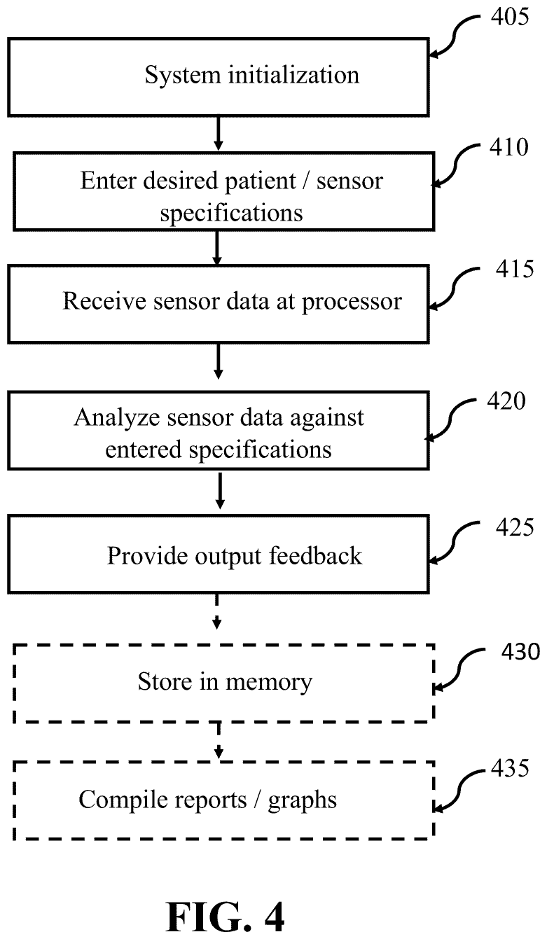

FIG. 4 illustrates a method of an example of the system that is configured to assess and provide feedback. At block 405, the system is initialized that allows a user to begin a manipulation process. The system is configured to allow the user to enter specifications at block 410 indicating desired output ranges, such as, for example, a range of sensitivities, a range of flexibility, a potential size of a patient, etc., for one or more of the sensors 30. It will be appreciated that the sensors 30 may be specified individually or as one group. Additional specifications may include one or more of: a gender, a size, an age, a flexibility, a sensitivity, etc., characterizing the patient. One or both of the processor 15 or computing device 40 sets the ranges in memory 20 in order to compare physical manipulative treatments to the specified desired ranges. The FIG. 10 and sensors 30 are configured to receive a pressure, force, bend, rotation, or other manipulative movement in a region. The sensor located at the region of manipulation transmits at block 415 the data to the processor 15 and/or the computing device 40 via the transceiver 35. One or both of the processors analyze and compare the received sensor data to the desired specification at block 420 and outputs one or more indicators at block 425. Advantageously, the system is configured to provide the user with real-time feedback. The user will know immediately, for example, whether to apply more or less pressure and/or more or less rotation, for example. At block 430, the system may optionally store the sensor data and outputted feedback in memory. The system is, optionally, configured to include session statistics, for example a percent accuracy, location-based accuracy (e.g., is the student better at spinal vs. extremity adjustments, is the user better at back vs. hip adjustments, etc.), frequency of training, etc. configured to compile the results and feedback into various graphs and/or reports at block 435.

The systems and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processor on the XXX and/or computing device. The computer-readable medium can be stored on any suitable computer-readable media such as RAMs. ROMs, flash memory, EEPROMs, optical devices (e.g., CD or DVD), hard drives, floppy drives, or any suitable device. The computer-executable component is preferably a general or application-specific processor, but any suitable dedicated hardware or hardware/firmware combination can alternatively or additionally execute the instructions.

As used in the description and claims, the singular form “a”, “an” and “the” include both singular and plural references unless the context clearly dictates otherwise. For example, the term “sensor” may include, and is contemplated to include, a plurality of sensors. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a length or pressure), indicates approximations which may vary by (+) or (−) 5%, 1% or 0.1%. All numerical ranges provided herein are inclusive of the stated start and end numbers. The term “substantially” indicates mostly (i.e., greater than 50%) or essentially all of a device, substance, or composition.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed disclosure. “Consisting of” shall mean that the devices, systems, and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A device for training medical practitioners, comprising:
a figure with an internal skeleton, the figure and the internal skeleton shaped to mimic at least a portion of a human body;
one or more sensors placed at joints inside the figure such that a motion of the figure induced by a user triggers the one or more sensors to produce one or more signals;
a processor comprising a database of consequences of a plurality of motions;
the processor configured to receive the one or more signals, determine the motion of the figure, and notify the user of the consequences of the motion.

2. The device of claim 1, wherein the one or more sensors comprise one or more of: pressure transducers, force transducers, motion sensors, conductive touch sensors, tactile sensors, piezoresistive sensor, torque sensors, or combinations thereof.

3. The device of claim 1, wherein the consequences comprise one or more of: pain-inducing, pain-relieving, alignment-correcting, misalignment-causing, and combinations thereof.

4. A device for training medical practitioners, comprising:
a figure shaped to mimic at least a portion of a human body;
one or more sensors placed at one or more anatomical regions inside the figure such that a motion of the figure induced by a user triggers the one or more sensors to produce one or more signals;
a processor comprising a database of consequences of a plurality of motions;
the processor configured to receive the one or more signals, determine the motion of the figure, and notify the user of the consequences of the motion.

5. The device of claim 4, wherein the sensors comprise one or more of: pressure transducers, force transducers, motion sensors, conductive touch sensors, tactile sensors, piezoresistive sensor, torque sensors, or combinations thereof.

6. The device of claim 5, wherein the sensors may include one or more of adjustable or non-adjustable sensors.

7. The device of claim 4, wherein the processor is configured to receive one or more input specifications in reference to the figure, the input specifications comprising one or more of: a sensor measurement range; a sensitivity; a flexibility; an age; a gender; or equivalents and combinations thereof.

8. A computer-implemented method for assessing one or more manipulative treatments and providing feedback, the method comprising:
receiving, from one or more sensors located in various positions on or within a training figure, one or more sensor signals indicative of a manipulative treatment on the training figure;
comparing the sensor signals with stored specifications relating to the one or more sensors;
outputting one or more indicators correlating to the comparison.

9. The method of claim 8, wherein the specifications comprising one or more of: a sensor measurement range; a sensitivity; a flexibility; an age; a gender; or equivalents and combinations thereof.

10. The method of claim 8, wherein the sensors comprise one or more of: pressure transducers, force transducers, motion sensors, conductive touch sensors, tactile sensors, piezoresistive sensor, torque sensors, or combinations thereof.

11. The device of claim 10, wherein the sensors may include one or more of adjustable or non-adjustable sensors.
